(19) United States
(12) Patent Application Publication
(10) Pub. No.: US 2013/0000670 A1
(43) Pub. Date: Jan. 3, 2013

(54) TOOTHBRUSH FOR PROVIDING SUBSTANTIALLY INSTANT FEEDBACK

(76) Inventors: Curt Binner, Furlong, PA (US); Richard J. Fougere, Washington Crossing, PA (US); Naomi Furgiuele, Doylestown, PA (US); Curtis Lee, Titusville, NJ (US); Megha Reddy, Princeton, NJ (US)

(21) Appl. No.: 13/170,468

(22) Filed: Jun. 28, 2011

(51) Int. Cl. A46B 9/04; B08B 1/00

(52) U.S. Cl. 134/6; 15/167.1

(57) ABSTRACT

A toothbrush containing a handle, a neck, a brush head region extending from the neck and including cleaning elements extending from a base thereof, a motion sensor for acquiring data indicative of motion of the toothbrush along at least one direction thereof concurrent with brushing, a microprocessor for analyzing the data indicative of motion of the toothbrush concurrent with brushing; and means to provide feedback to a user of the toothbrush, wherein the motion sensor, the microprocessor and the feedback means cooperate to provide the user substantially instant feedback, such that the user may adjust brushing motion while brushing teeth, and methods of providing substantially instant feedback to the user of the toothbrush.

### FIELD OF THE INVENTION

The present invention relates to manual or power toothbrush devices adapted to provide substantially instant feedback to alert users thereof if they are brushing too aggressively.

### BACKGROUND OF THE INVENTION

The effectiveness of using a toothbrush to remove plaque from tooth surfaces, while being gentle on gums, is affected by the user's brushing motion, brushing duration, and the force applied by the user during brushing. Dental professionals have integrated these parameters to form a “recommended brushing technique”, which is taught to dental patients during visits to the dentist.

In some cases the user's brushing motion is measured using accelerometer technology where data is provided indirectly to the user after brushing is completed. In one such case, data gathered by a manual toothbrush may be used to provide a user and/or the user's dentist with an accurate evaluation of the user's brushing technique during a brushing session. The toothbrush acquires a time sequence of data regarding the user's brushing motion, force and duration during brushing, stores the data, and then analyzes it using a second device. A user interface between the toothbrush and the second device allows the toothbrush user and/or the user's dentist to view a simulation of a brushing session. Data from multiple brushing sessions may also be stored so that a history of the patient's brushing technique and regimen can be compiled and studied. The manual brush, however, does not provide the user with direct, instantaneous feedback during the brushing session.

In addition, the technique used to brush teeth with a power toothbrush can be different than the technique for a manual brush. In the case of a power toothbrush, the technique should be to gently glide the head of the toothbrush over the teeth, allowing the power-driven bristles to perform the cleaning.

What is needed is a toothbrush, manual or power, which monitors the pattern of brushing, and provides direct, substantially instantaneous feedback to the user during the brushing session to alert them if they are brushing too aggressively, so that they can adjust their brushing technique during the brushing session to be more safe and effective.

### SUMMARY OF THE INVENTION

The present invention is in regards to a toothbrush that includes a handle, a neck, a brush head region extending from the neck, which brush head region comprises cleaning elements extending from a base thereof, a motion sensor for acquiring data indicative of motion of the toothbrush along at least one direction of the toothbrush concurrent with brushing, a microprocessor for analyzing the data indicative of motion of the toothbrush concurrent with brushing and means to provide feedback to a user of the toothbrush concurrent with brushing regarding the level of aggressiveness of the brushing technique. The motion sensor, the microprocessor and the feedback means cooperate, as described herein, to provide the user substantially instant feedback, such that the user may adjust brushing motion while brushing teeth. The present invention is also in regards to methods utilizing such toothbrushes.

### BRIEF DESCRIPTION OF THE DRAWINGS

FIG. 1 is a top view of a toothbrush according to one embodiment of the invention.

FIG. 2 is a cross-sectional view of the toothbrush of FIG. 1 along the 2-2 plane of FIG. 1.

FIG. 3 is a representation of a first embodiment method of using the power toothbrush of the present invention.

FIG. 4 is a representation of a second embodiment method of using the power toothbrush of the present invention.

FIG. 5 is a representation of a third embodiment method of using the power toothbrush of the present invention.

FIG. 6a is a graph of the x-motion of one embodiment powered toothbrush of the present invention indicating that the toothbrush is being used in an aggressive manor.

FIG. 6b is a graph of the x-motion of the embodiment depicted in FIG. 6a when the toothbrush is not being used in an aggressive manor.

### DETAILED DESCRIPTION OF THE INVENTION

One method according to the present invention described herein provides a method comprising the steps of acquiring data concurrent with brushing, where the data is indicative of motion of a manual or power toothbrush along the longitude and/or latitude of the toothbrush, analyzing the data concurrent with brushing, and providing feedback to the user concurrent with brushing to alert them if they are brushing too aggressively, so that they may adjust brushing motion while brushing. As used herein, “substantially instant feedback” means that the data indicative of motion acquired from the toothbrush during brushing is analyzed concurrent with brushing to determine if the user is brushing aggressively, and feedback is provided to the user concurrent with brushing to alert the user if they are brushing aggressively, such that the user may adjust brushing motion while brushing the teeth. The acquired data is not stored in a separate component of the toothbrush for analysis after the user completes brushing the teeth.

The phrase “manual toothbrush” means a toothbrush with cleaning elements, such as bristles, which motion depends on the motions generated by the toothbrush user. The phrase “power toothbrush” means a toothbrush with cleaning elements, such as bristles, which motion, such as vibratory or rotational motion of the cleaning elements, depends on motion generated by electric power. Power toothbrushes are also called power-assisted toothbrushes. The phrase “brushing aggressively” means that the user is moving the brush within the oral cavity with a high frequency and/or amplitude. Definitions of high frequency and high amplitude will be discussed later. Brushing aggressively can cause gum erosion at the base of the teeth.

The method includes acquiring data indicative of motion of the toothbrush along at least one direction, such as the x, y, or z-axis of the brush. In some embodiments, data indicative of motion of the toothbrush along two directions, or axes, may be acquired. In other embodiments, data indicative of motion of the toothbrush along three directions, or axes, may be acquired.

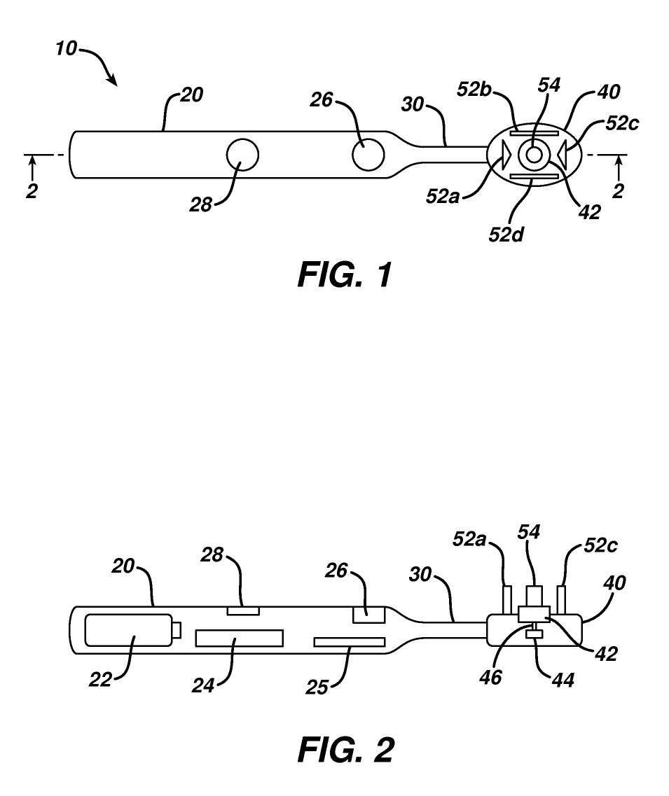

One embodiment of a toothbrush used in monitoring the brushing technique and providing substantially instant feedback to the user to alert them if they are brushing too aggressively is shown in FIGS. 1 and 2. FIG. 1 is a top view of toothbrush 10, while FIG. 2 is a cross-sectional view of toothbrush 10 along the 2-2 plane of FIG. 1. Toothbrush 10 includes handle 20, neck 30, and brush head 40.

Within handle 20 is mounted power supply 22, e.g. a battery, microprocessor 24, motion sensor 25, means for providing feedback 26 to the user to alert them if they are brushing too aggressively, and power switch 28. Though not shown, power supply 22 is connected to microprocessor 24, motion sensor 25, feedback means 26, and power switch 28. Together, motion sensor 25, microprocessor 24 and feedback means 26 cooperate to provide the user of the toothbrush with substantially instant feedback as to whether or not they are brushing aggressively. The manner in which data is acquired and analyzed during operation of the toothbrush will be discussed in further detail below.

Motion sensor 25 could be, for example, an accelerometer, a gyroscope, or a combination thereof. In some embodiments, motion sensor 25 is a single-axis accelerometer used to measure acceleration in the x, i.e. longitude, direction of the toothbrush as depicted in FIGS. 1 and 2, as a function of time. In other embodiments, motion sensor 25 is a two-axis accelerometer and is used to measure acceleration in the x (longitude) and y (latitude) directions of the toothbrush as depicted in FIGS. 1 and 2, as a function of time. This is the movement of the toothbrush in the plane of the toothbrush head. In still other embodiments, motion sensor 25 is a three-axis accelerometer and is used to measure acceleration in the x, y, and z directions of the toothbrush depicted in FIGS. 1 and 2, as a function of time. This is the three-dimensional movement of the toothbrush head. When a substantially constant current is supplied to the accelerometer, e.g. by a battery, the resistance of the accelerometer changes in response to motion, resulting in a varying voltage output, according to the equation V=IR. Suitable accelerometers are available from numerous suppliers, such as Vernier Software (Portland, Oreg.), Analog Devices (Norwood, Mass.), or STMicroelectronics (Carrollton, Tex.).

Microprocessor 24 receives acceleration data from the accelerometer at a data acquisition rate (sampling rate) of from about 10 to about 200 samples/second, optionally from about 50 to about 120 samples/second. Microprocessor 24 may be in the form of a commercially available chip, such as can be purchased from Texas Instruments (Dallas, Tex.), Atmel Corporation (San Jose, Calif.), Microchip Technology (Chandler, Ariz.), Intel Corporation (Santa Clara, Calif.), and STMicroelectronics (Carrollton, Tex.).

Feedback means 26 provides a signal sent to the user to inform the user that they are brushing too aggressively. The signal may be in a number of forms. These signals may be in forms directed to any of the five senses of sight, sound, touch, smell, or taste, or combinations thereof. In one embodiment, feedback means 26 may be a light, or a series of lights, on or embedded in the surface of handle 20. The lights may be off while the user is not brushing too aggressively, and illuminate when the user is brushing too aggressively.

In another embodiment, lights of two colors can be used. Here, an illuminated light of a first color informs the user that the user is not brushing too aggressively. If the user begins brushing too aggressively, illuminated light of the first color dims, and illuminated light of a second color brightens.

In one embodiment, the signal provided by feedback means 26 may be in the form of a sound, or a series of sounds, used in a similar manner as discussed above. Changing volume, pitch, tone, or frequency are all possible signals. In still other embodiments, feedback means 26 may provide vibrational motion as a signal to alert the user if they are brushing too aggressively.

As mentioned, the toothbrush of the present invention includes a handle, neck and a brush head. The brush head will have cleaning elements, usually in the form of bristles arranged in tufts. Cleaning tufts are made of approximately 20 to 50 individual bristles arranged on the face of the brush head in a manner to optimize cleaning of the surfaces of the teeth. FIG. 1 shows one arrangement of tufts 52, 54 on brush head 40. It is to be understood that the arrangement of tufts 52, 54 on brush head 40, which may either be in the form of stationary tufts 52, or movable tufts 54, is not limiting in the scope of the present invention. Typical tufts are approximately 0.063 inches (1.6 mm) in diameter, with a cross-sectional area of approximately 0.079 inches² (2 mm²). The diameters of commonly used bristles are 0.006 inch (0.15 mm) for soft bristles, 0.008 inch (0.2 mm) for medium bristles, and 0.010 inch (0.25 mm) for hard bristles.

As shown in the embodiment of FIGS. 1 and 2, brush head 40 includes cleaning elements in the form of stationary bristles arranged in tufts 52. The embodiment shows stationary tufts 52a, 52b, 52c and 52d at the toe, heel and sides, respectively, of brush head 40. In this embodiment, brush head 40 also includes movable bristles arranged in tufts 54. Movable tufts 54 may be disposed on a carrier 42 i.e. a bristle plate or bristle mounting plate, which is connected by, e.g. shaft 46, to a means for causing tuft motion 44. Means for causing tuft motion 44 include, but are not limited to, devices that cause translational, rotational, or vibrational motion.

Although tufts 52 and 54 shown in the embodiment of FIGS. 1 and 2 are substantially perpendicular to the brush handle in the embodiments described above and shown in the figures, other bristle geometries and brush designs may be used. For example, the bristles may be angled with respect to the head region of the brush handle.

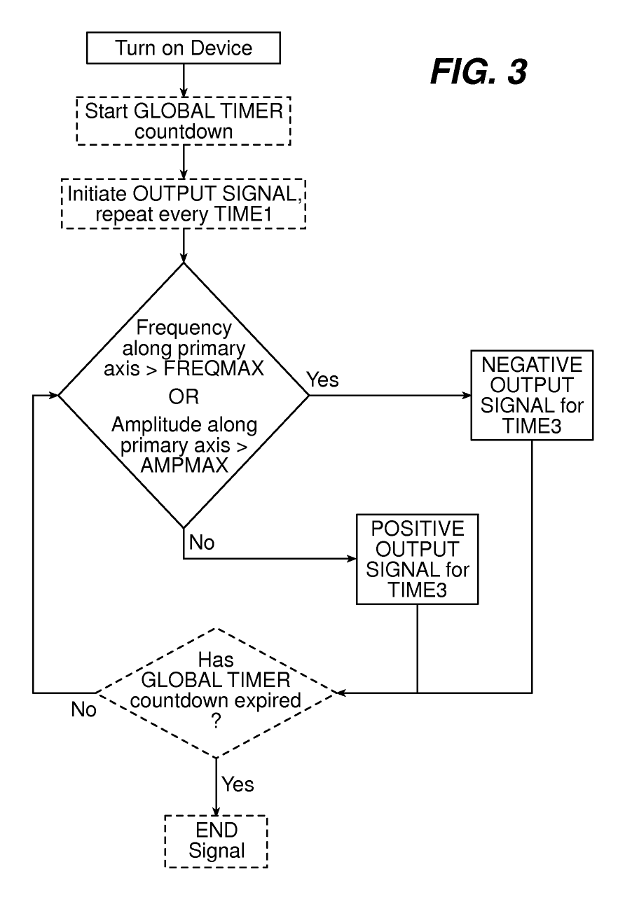

There are a numbers of different methods, or modes, of using toothbrush 10 of the present invention in providing substantially instant feedback to the user to alert them if they are brushing too aggressively. FIG. 3 illustrates a first embodiment method of use of toothbrush 10. In this embodiment, the user moves toothbrush 10 in the mouth preferably using a standard cleaning motion. The user may receive a POSITIVE OUTPUT SIGNAL from toothbrush 10 when they are not brushing too aggressively. The user will receive a NEGATIVE OUTPUT SIGNAL from toothbrush 10 when they are brushing too aggressively. The terms “POSITIVE” and “NEGATIVE” are used herein to indicate that the brushing technique being employed is acceptable or unacceptable, respectively, and do not have any other technical meaning associated therewith. In certain embodiments, the respective POSITIVE and/or NEGATIVE OUTPUT SIGNALS may be continuous through the brushing period. In other embodiments, the respective POSITIVE and/or NEGATIVE OUTPUT SIGNALS may be intermittent over the course of the brushing period.

In the first step, toothbrush 10 is turned on. Next, an optional internal countdown GLOBAL TIMER is set to a predetermined tooth brushing time. The predetermined tooth brushing time could be 180, 150, 120, 90, 75, 60, 45, or 30 seconds, for example, and can be set by the manufacturer, or by the user, based on current oral health practices. In this optional step, the internal countdown GLOBAL TIMER is started.

Progressing to the next step, an optional OUTPUT SIGNAL may be used to inform the user that the toothbrush is activated. The signal may be in a number of forms directed to any of the five senses: sight (light), sound, touch (vibration), smell, or taste. A separate timer can then be started, and at intervals of TIME1, the optional OUTPUT SIGNAL can be sent to inform the user that they should, for example, move to another quadrant, or to indicate that the device is activated, should the user forget to deactivate it at the end of a brushing session. TIME1 could be 30, 20, 15, 10, or 5 seconds, for example.

Progressing to the next step, motion sensor 25 measures the displacement of the brush along the primary axis, e.g. x-axis. Microprocessor 24 begins to receive the time sequence of data concerning the motion of the toothbrush from motion sensor 25. The microprocessor then calculates the value of frequency, i.e. calculated frequency, of motion along the primary, e.g. x-axis, and the value of the amplitude, i.e. calculated amplitude, of motion along the primary, e.g. x-axis. Data may be acquired continually at intervals of time such as 1, 0.5, 0.25, 0.125, 0.1, 0.05, 0.025, 0.0125, 0.01, 0.005, or less seconds. The time intervals for data acquired may be regular, or may be chosen randomly.

The stream of data obtained may be put through a low pass digital filter within the microprocessor to remove high frequency noise within the data to allow the user's motions to be more apparent and allow peak, i.e. maximum, and valley, i.e. minimum, detection to be more robust. Once the filtering is achieved, peak and valley detection can be achieved in a variety of ways; for instance by calculating the change in slope and monitoring when it changes from positive to negative, e.g. a peak, or negative to positive, e.g. a valley. Once the peaks and valleys are determined, the time between peaks becomes known and the frequency is calculated, and also the difference between a peak and the subsequent valley can be calculated to determine the amplitude. Further filtering can be accomplished by adding a requirement that the aggressive condition is met for a certain amount of time, 0.4 seconds, for example. This would ensure that the user is not notified of aggressive brushing technique in the event an instantaneous quick motion was experienced while brushing.

In the next step of the program, the operating program in microprocessor 24 reaches a first decision block. In this block, the value of the calculated frequency of motion along the primary axis is compared to a predetermined value of FREQMAX, and the value of the calculated amplitude of motion along the primary axis is compared to a predetermined value of AMPMAX. These comparisons may be performed sequentially or simultaneously. If performed sequentially, the order of comparison is not critical to the performance of toothbrush 10.

If the value of the calculated frequency of motion along the primary axis is greater than the value of FREQMAX, or if the value of the calculated amplitude of motion along the primary axis is greater than the value of AMPMAX, i.e. the “Yes” response to the first decision block on FIG. 3, the operating program in microprocessor 24 generates a NEGATIVE OUTPUT SIGNAL sent to the user via the feedback means to inform the user that the user is brushing too aggressively.

The values of FREQMAX and AMPMAX may be determined a number of ways. For example, the maximum values may be predetermined and programmed into the toothbrush prior to sale, or the maximum values may be determined based on a user's particular brushing habits. FREQMAX may be determined to be about two, or three, or greater, back and forth motions in the x-direction, i.e. longitudinal direction, of the brush per second. AMPMAX may be about 7 meter/sec2, or greater, of the acceleration of the brush.

As discussed in Example 2 below, these values may be determined by correlating observed brushing habits which may lead to gum and tooth damage with frequency/period and the amplitude of acceleration output. In Example 2 below, a frequency of about four (4) or greater back and forth motions in the x-direction of the brush per second (FREQMAX) and an amplitude of the acceleration of the brush of about 9 meter/sec² (AMPMAX) or greater were characterized as aggressive brushing.

Other methods which could be used to determine FREQMAX or AMPMAX are a sliding scale or a weighted scale. For a sliding scale, FREQMAX or AMPMAX may be based on the frequency of motion along the primary axis, or the value of the amplitude of motion along the primary axis. In a first embodiment, the value of the amplitude of motion along the primary axis is calculated. The value of FREQMAX is determined based on the calculated value of the amplitude of motion along the primary axis. For example, if the calculated amplitude of the acceleration of the brush is 3.0 meter/sec², FREQMAX can be set to 2. If, on the other hand, the calculated amplitude of the acceleration of the brush is 2.0 meter/sec², FREQMAX can be set to the higher value of 4.

In a second embodiment, the value of the frequency of motion along the primary axis is calculated. The value of AMPMAX is determined based on the value of the calculated frequency of motion along the primary axis. For example, if the calculated frequency of the brush is 2, AMPMAX can be set to 10 meter/sec². If, on the other hand, the calculated frequency of the brush is 4, AMPMAX can be set to the lower value of 5 meter/sec².

In some embodiments, amplitude and frequency may have a different impact on the overall aggressiveness of the brushing technique. In these embodiments, a weighted scale adding a multiplier to frequency and/or amplitude may be used to emphasize that specific motion.

If either the value of the calculated frequency of motion along the primary axis is not greater than the value of FREQMAX, or the value of the calculated amplitude of motion along the primary axis is not greater than the value of AMPMAX, i.e. the “No” response to the first decision block on FIG. 3, the user will receive a POSITIVE OUTPUT SIGNAL for a period of TIME3 to inform the user that the user is not brushing too aggressively.

As previously mentioned, feedback (as either a POSITIVE OUTPUT SIGNAL or a NEGATIVE OUTPUT SIGNAL) may be in the form of a signal or combination of signals directed to any of the five senses, e.g. sight, sound, touch, smell, or taste (or combination of senses). The signal will proceed for a period of time adequate for the user to determine whether or not they are brushing too aggressively (TIME3). In some embodiments, TIME3 could be values such as, but not limited to, 3, 2, 1, 0.5, or 0.25 seconds. In other embodiments, feedback may be continual, only ceasing when the user is no longer brushing too aggressively. In still other embodiments, feedback may be intermittent, alternating from POSITIVE to NEGATIVE, as determined by brushing technique.

Upon termination of the POSITIVE OUTPUT SIGNAL or the NEGATIVE OUTPUT SIGNAL, the operating program in microprocessor 24 proceeds to an optional second decision block shown in FIG. 3. In this block, the value of the internal countdown GLOBAL TIMER is examined. If the value of the internal countdown GLOBAL TIMER is 0, the operating program in microprocessor 24 generates an END signal sent to the user to inform the user that the cleaning process is complete. If the value of the internal countdown GLOBAL TIMER is greater than 0, the operating program in microprocessor 24 proceeds back to the first decision block, and the cleaning process continues. For embodiments without the optional second decision block, the operating program in microprocessor 24 proceeds back to the first decision block, and the cleaning process continues.

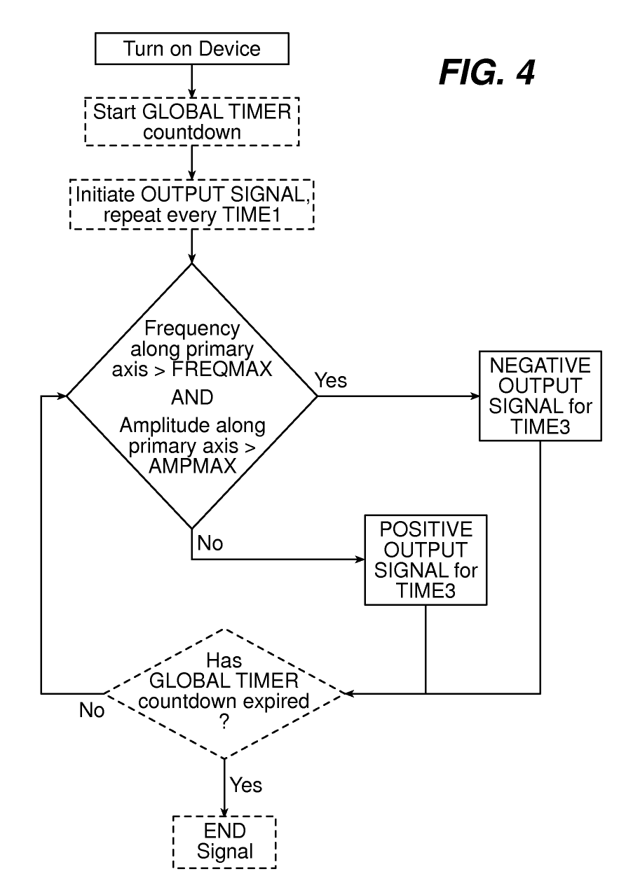

FIG. 4 illustrates a second embodiment method of use of toothbrush 10. In this embodiment, the user moves toothbrush 10 in the mouth using a standard cleaning motion. The user will receive a POSITIVE OUTPUT SIGNAL when they are not brushing too aggressively. The user will receive a NEGATIVE OUTPUT SIGNAL when they are brushing too aggressively. In this embodiment, motion is detected along a primary axis.

In the first step, toothbrush 10 is turned on. Next, an optional internal countdown GLOBAL TIMER is set to a predetermined tooth brushing time. The predetermined tooth brushing time could be 180, 150, 120, 90, 75, 60, 45, or 30 seconds, for example, and can be set by the manufacturer, or by the user, based on current oral health practices. In this step, the internal countdown GLOBAL TIMER is started.

Progressing to the next step, an OUTPUT SIGNAL may be used to inform the user that the toothbrush is activated. The signal may be in a number of forms directed to any of the five senses, e.g. sight (light), sound, touch (vibration), smell, or taste. A separate timer can then be started, and at intervals of TIME1, the optional OUTPUT SIGNAL can be sent to inform the user that they should, for example, move to another quadrant, or to indicate that the device is activated, should the user forget to deactivate it at the end of a brushing session. TIME1 could be 30, 20, 15, 10, or 5, seconds, for example.

Progressing to the next step, motion sensor 25 measures the displacement of the brush along the primary axis, e.g. x-axis. Microprocessor 24 begins to receive the time sequence of data concerning the motion of the toothbrush from motion sensor 25. The microprocessor then calculates the value of frequency, i.e. calculated frequency, of motion along the primary, e.g. x-axis, and the value of the amplitude, i.e. calculated amplitude, of motion along the primary, e.g. x-axis. Data may be acquired continually at intervals such as 1, 0.5, 0.25, 0.125, 0.1, 0.05 0.025, 0.0125, 0.01, or 0.005, or less. The time intervals for data points acquired may be regular, or may be chosen randomly.

As mentioned above, the stream of data obtained may be put through a series of filters within the microprocessor to filter out noise within the data.

In the next step of the program, the operating program in microprocessor 24 reaches a first decision block. In this block, the value of the calculated frequency of motion along the primary axis is compared to a predetermined value of FREQMAX, and the value of the calculated amplitude of motion along the primary axis is compared to a predetermined value of AMPMAX. These comparisons may be performed sequentially or simultaneously. If performed sequentially, the order of comparison is not critical to the performance of toothbrush 10.

If the value of the calculated frequency of motion along the primary axis is greater than the value of FREQMAX, and the value of the calculated amplitude of motion along the primary axis is greater than the value of AMPMAX, i.e. the “Yes” response to the first decision block on FIG. 4, the operating program in microprocessor 24 generates a NEGATIVE OUTPUT SIGNAL sent to the user via the feedback means to inform the user that the user is brushing too aggressively.

If either the value of the calculated frequency of motion along the primary axis is not greater than the value of FREQMAX, or the value of the calculated amplitude of motion along the primary axis is not greater than the value of AMPMAX, i.e. the “No” response to the first decision block on FIG. 4, the user will receive a POSITIVE OUTPUT SIGNAL for a period of TIME3 to inform the user that the user is not brushing too aggressively.

As previously mentioned, feedback may be in the form of a signal, or multiple signals, directed to any of the five senses, e.g. sight, sound, touch, smell, or taste, or a combination of senses. The signal will proceed for a period of time adequate for the user to determine whether or not they are brushing too aggressively (TIME3). In some embodiments, TIME3 could be values such as, but not limited to, 3, 2, 1, 0.5, or 0.25 seconds. In other embodiments, feedback may be continual, only ceasing when the user is no longer brushing too aggressively. In still other embodiments, feedback may be intermittent, alternating from POSITIVE to NEGATIVE, as determined by brushing technique.

Upon termination of the POSITIVE OUTPUT SIGNAL or the NEGATIVE OUTPUT SIGNAL, the operating program in microprocessor 24 proceeds to an optional second decision block shown in FIG. 4. In this block, the value of the internal countdown GLOBAL TIMER is examined. If the value of the internal countdown GLOBAL TIMER is 0, the operating program in microprocessor 24 has an END signal sent to the user to inform the user that the cleaning process is complete. If the value of the internal countdown GLOBAL TIMER is greater than 0, the operating program in microprocessor 24 proceeds back to the first decision block, and the cleaning process continues. For embodiments without the optional second decision block, the operating program in microprocessor 24 proceeds back to the first decision block, and the cleaning process continues.

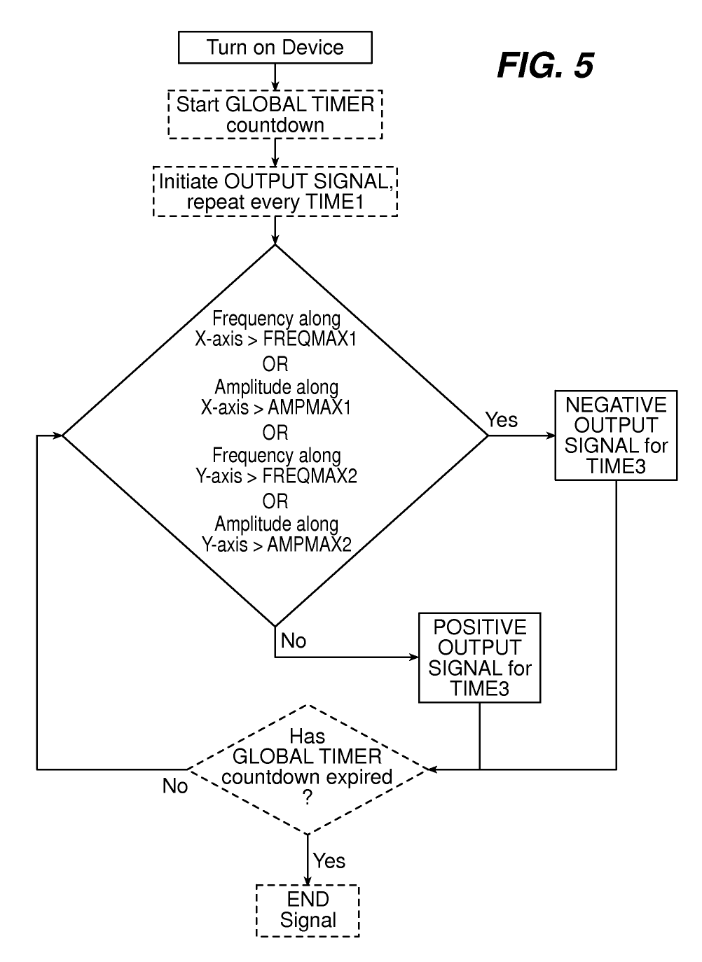

FIG. 5 illustrates a third embodiment method of use of toothbrush 10. In this embodiment, the user moves toothbrush 10 in the mouth using a standard cleaning motion. The user will receive a POSITIVE OUTPUT SIGNAL when they are not brushing too aggressively. The user will receive a NEGATIVE OUTPUT SIGNAL when they are brushing too aggressively. In this embodiment, motion is detected along 2 axes, the x-axis, and the y-axis.

In the first step, toothbrush 10 is turned on. Next, an optional internal countdown GLOBAL TIMER is set to a predetermined tooth brushing time. The predetermined tooth brushing time could be 180, 150, 120, 90, 75, 60, 45, or 30 seconds, for example, and can be set by the manufacturer, or by the user, based on current oral health practices. In this step, the internal countdown GLOBAL TIMER is started.

Progressing to the next step, an optional OUTPUT SIGNAL is used to inform the user that the toothbrush is activated. The signal may be in a number of forms directed to any of the five senses, i.e. sight (light), sound, touch (vibration), smell, or taste. A separate timer can then be started, and at intervals of TIME1, the optional OUTPUT SIGNAL can be sent to inform the user that they should, for example, move to another quadrant, or to indicate that the device is activated, should the user forget to deactivate it at the end of a brushing session. TIME1 could be 30, 20, 15, 10, or 5, seconds, for example.

Progressing to the next step, motion sensor 25 measures the displacement of the brush along the primary axis, e.g. x-axis. Microprocessor 24 begins to receive the time sequence of data concerning the motion of the toothbrush from motion sensor 25. The microprocessor then calculates the value of frequency, i.e. calculated frequency, of motion along the primary, e.g. x-axis, and the value of the amplitude, i.e. calculated amplitude, of motion along the primary, e.g. x-axis. Data may be taken at intervals such as 1, 0.5, 0.25, 0.125, 0.1, 0.05 0.025, 0.0125, 0.01, or 0.005, or less, seconds. The time intervals for data points acquired may be regular, or may be chosen randomly.

As mentioned above, the stream of data collected may be put through a series of filters within the microprocessor to filter out the noise within the data.

In the next step of the program, the operating program in microprocessor 24 reaches a first decision block. In this block, the value of the calculated frequency of motion along the x-axis is compared to a predetermined value of FREQMAX1, the value of the calculated amplitude of motion along the x-axis is compared to a predetermined value of AMPMAX1, the value of the calculated frequency of motion along the y-axis is compared to a predetermined value of FREQMAX2, and the value of the calculated amplitude of motion along the y-axis is compared to a predetermined value of AMPMAX2. If the value of the calculated frequency of motion along the x-axis is greater than the value of FREQMAX1, or if the value of the calculated amplitude of motion along the x-axis is greater than the value of AMPMAX1, or if the value of the calculated frequency of motion along the y-axis is greater than the value of FREQMAX2, or if the value of the calculated amplitude of motion along the y-axis is greater than the value of AMPMAX2, i.e. the “Yes” response to the first decision block on FIG. 5, the operating program in microprocessor 24 sends a NEGATIVE OUTPUT SIGNAL to the user via the feedback means to inform the user that the user is brushing too aggressively.

If the value of the calculated frequency of motion along the x-axis is less than the value of FREQMAX1, and the value of the calculated amplitude of motion along the x-axis is less than the value of AMPMAX1, and the value of the calculated frequency of motion along the y-axis is less than the value of FREQMAX2, and the value of the calculated amplitude of motion along the y-axis is less than the value of AMPMAX2, i.e. the “No” response to the first decision block on FIG. 5, the operating program in microprocessor 24 sends a POSITIVE OUTPUT SIGNAL to the user via the feedback means to inform the user that the user is not brushing too aggressively. As previously mentioned, feedback may be in the form of a signal or combination of signals directed to any of the five senses: sight, sound, touch, smell, or taste (or combination of senses). The signal will proceed for a period of time adequate for the user to determine that they are brushing too aggressively (TIME3). In some embodiments, TIME3 could be values such as, but not limited to, 3, 2, 1, 0.5, or 0.25 seconds. In other embodiments, feedback may be continual, only ceasing when the user is no longer brushing too aggressively. In still other embodiments, feedback may be intermittent.

Note that in the embodiment shown in FIG. 5, a NEGATIVE OUTPUT SIGNAL is sent to the user to inform the user that the user is brushing too aggressively if any one of the values of FREQMAX1, AMPMAX1, FREQMAX2, and AMPMAX2, is exceeded. In another embodiment, a NEGATIVE OUTPUT SIGNAL is sent to the user to inform the user that the user is brushing too aggressively if all of the values of FREQMAX1, AMPMAX1, FREQMAX2, AMPMAX2, are exceeded. In yet other embodiments, a NEGATIVE OUTPUT SIGNAL is sent to the user if two or three of the values of FREQMAX1, AMPMAX1, FREQMAX2, AMPMAX2, are exceeded.

Upon termination of the POSITIVE OUTPUT SIGNAL or the NEGATIVE OUTPUT SIGNAL, the operating program in microprocessor 24 proceeds to an optional second decision block shown in FIG. 5. In this block, the value of the internal countdown GLOBAL TIMER is examined. If the value of the internal countdown GLOBAL TIMER is 0, the operating program in microprocessor 24 has an END signal sent to the user to inform the user that the cleaning process is complete. If the value of the internal countdown GLOBAL TIMER is greater than 0, the operating program in microprocessor 24 proceeds back to the first decision block, and the cleaning process continues. For embodiments without the optional second decision block, the operating program in microprocessor 24 proceeds back to the first decision block, and the cleaning process continues.

In other embodiments, the manual or power toothbrush includes a replaceable brush portion. Here, the sensor(s) are not in the head region, and the head can be removable and replaceable. The head can be connected, for example, by threaded engagement with the handle so that the brush can continue to be used after bristle wear has occurred. Any desired type of removable head or bristle cartridge can be used.

### EXAMPLES

The following example is illustrative only and should not be construed as limiting the invention in any way. Those skilled in the art will appreciate that variations are possible which are within the spirit and scope of the appended claims.

### Example 1

A power toothbrush containing an x-axis, i.e. longitudinal axis, accelerometer attached thereto was prepared. A study was conducted whereby twenty-six subjects were observed brushing their teeth with the toothbrush. Each subject was observed by a professional accredited dentist to characterize and identify brushing habits which may lead to gum and tooth damage. The observation took place behind a one-way mirror to prevent any interference between the subjects brushing techniques and the dentist observing the brushing. During the brushing, the stroke speed and length of stroke were characterized by the dentist on a 1 to 9 scale, with 1 being gentle and 9 being aggressive. The dentist also characterized brushing behavior from both gentle to aggressive on a 1 (gentle) to 9 (aggressive) scale. Brushing habits which displayed aggressive or damaging characteristics (a dentist's rating of above 6) were then correlated to the frequency/period and the amplitude of acceleration output from the accelerometer. The amplitude of the acceleration and the frequency output from the accelerometer was used to identify the actual stroke length, velocity, time between cycles, and position of the brush during brushing.

In this example the method used to determine aggressive brushing was a standard limit requirement for both frequency and amplitude. Based upon the twenty-six subject study, a frequency of greater than four (4) back and forth motions in the x-direction of the brush per second (FREQMAX) and an amplitude of the acceleration of the brush of greater than about 9 meter/sec² (AMPMAX) were characterized as aggressive brushing.

### Example 2

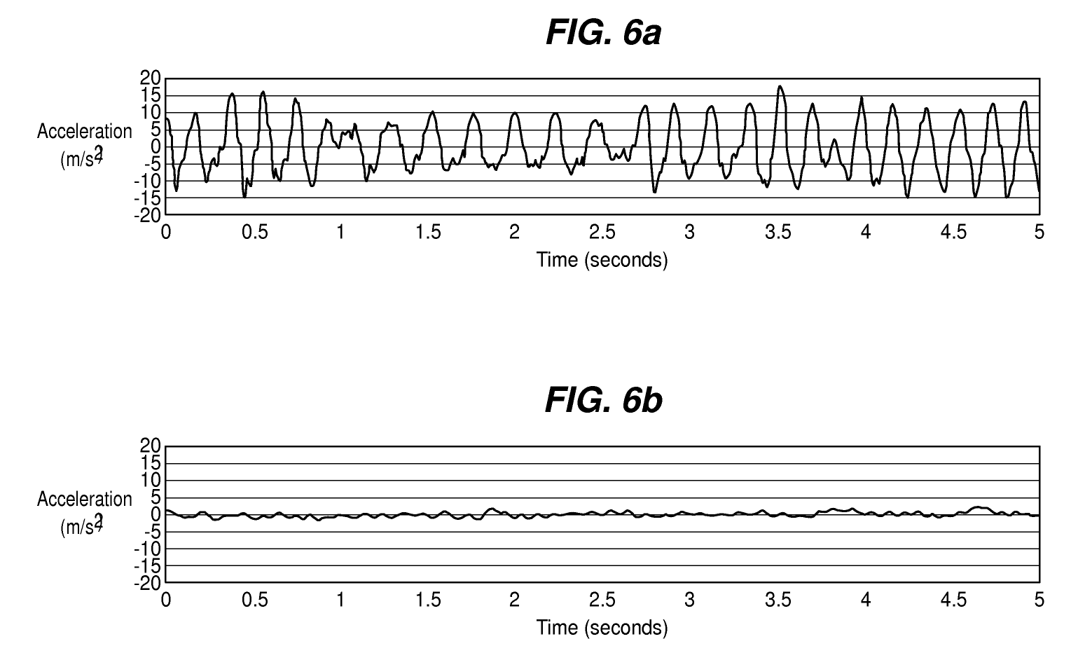

A power toothbrush an x-axis, i.e. longitudinal axis, accelerometer attached thereto was prepared. FREQMAX and AMPMAX were determined based upon the data from Example 1. The brush was turned on and then moved to simulate brushing aggressively. FIG. 6a is a graph of the motion of the powered toothbrush in the x-direction, i.e. longitude, when the toothbrush is being used in an aggressive manner, i.e. large, fast strokes.

The power toothbrush was then used to simulate brushing gently. FIG. 6b is a graph of the motion of the powered toothbrush in the x-direction, i.e. longitude, when the toothbrush is not being used in an aggressive manner, i.e. small, slow strokes. The graphs show the difference between aggressive and non-aggressive brushing. The data obtained may be inputted into the algorithm to provide feedback to the user regarding their brushing technique, such that the user may adjust brushing technique while brushing in the case where aggressive brushing is detected.

What is claimed is:

1. A toothbrush, comprising:
a handle,
a neck,
a brush head region extending from said neck, said brush head region comprising cleaning elements extending from a base thereof,
a motion sensor for acquiring data indicative of motion of said toothbrush along at least one direction of said toothbrush concurrent with brushing,
a microprocessor for analyzing said data indicative of motion of said toothbrush concurrent with brushing; and
means to provide feedback to a user of said toothbrush concurrent with brushing, wherein said motion sensor, said microprocessor and said feedback means cooperate to provide said user substantially instant feedback.

2. The toothbrush of claim 1 wherein said motion sensor, said microprocessor and said feedback means are disposed within said handle.

3. The toothbrush of claim 1 wherein said feedback means provides a signal directed to the senses of said user selected from the group consisting of sight, sound, touch, smell and taste.

4. The toothbrush of claim 1 wherein said data is indicative of motion along the longitudinal axis of said toothbrush.

5. The toothbrush of claim 1 wherein said motion sensor comprises an accelerometer.

6. The toothbrush of claim 5 wherein said accelerometer is a multi-axis accelerometer.

7. The toothbrush of claim 5 wherein said accelerometer is a single-axis accelerometer.

8. The toothbrush of claim 5 wherein said data indicative of motion comprises acceleration data.

9. The toothbrush of claim 8 wherein said microprocessor provides calculated frequency of acceleration and calculated amplitude of acceleration.

10. The toothbrush of claim 8 wherein said microprocessor compares said calculated frequency to a predetermined maximum frequency and compares said calculated amplitude to a predetermined maximum amplitude.

11. The toothbrush of claim 1 selected from the group consisting of a power toothbrush and a manual toothbrush.

12. A method for providing substantially instant feedback to a user of a toothbrush, the method comprising:
providing said toothbrush that comprises,
a motion sensor for acquiring data indicative of motion of said toothbrush along at least one direction of said toothbrush concurrent with brushing,
a microprocessor for analyzing said data indicative of motion of said toothbrush concurrent with brushing; and
means to provide feedback to a user of said toothbrush concurrent with brushing,
acquiring said data indicative of motion of said toothbrush along at least one direction of said toothbrush concurrent with brushing,
analyzing said data indicative of motion of said toothbrush concurrent with brushing; and
providing feedback to said user of said toothbrush concurrent with brushing, wherein said motion sensor, said microprocessor and said feedback means cooperate to provide said user substantially instant feedback.

13. The method of claim 12 wherein said data indicative of motion comprises acceleration data.

14. The method of claim 13 wherein analysis of said acceleration data comprises calculating frequency and amplitude of acceleration of said toothbrush in said at least one direction and comparing said calculated frequency of acceleration with a predetermined maximum frequency and comparing said calculated amplitude of acceleration with a predetermined maximum amplitude of said acceleration.

15. The method of claim 14 wherein said feedback means provides said user a signal to alert said user that said brushing is aggressive.

16. The method of claim 14 wherein said feedback comprises a signal provided to said user if both of said calculated frequency and said calculated amplitude of acceleration exceeds said predetermined maximum frequency or said predetermined maximum amplitude of acceleration to alert said user that said brushing is aggressive.

17. The method of claim 15 wherein said feedback comprises a signal provided to said user if either of said calculated frequency or said calculated amplitude of acceleration exceeds said predetermined maximum frequency or said predetermined maximum amplitude of acceleration to alert said user that said brushing is aggressive.
